(19) United States
(12) Patent Application Publication
(10) Pub. No.: US 2025/0202101 A1
(43) Pub. Date: Jun. 19, 2025

(54) REMOTE ELECTRICAL TILT CHANGES IN A WIRELESS NETWORK

(71) Applicant: T-Mobile Innovations LLC, Overland Park, KS (US)

(72) Inventor: Rongjie JI, Lisle, IL (US)

(21) Appl. No.: 18/538,177

(22) Filed: Dec. 13, 2023

(51) Int. Cl. H01Q 3/00; H01Q 21/06

(52) U.S. Cl. CPC H01Q 3/005; H01Q 21/06

(57) ABSTRACT

Validating RET changes in a wireless network includes receiving information associated with a RET change for use by at least one access node from a antennas in a geographic area, the RET change having at least one RET change not previously implemented in the wireless network, performing a configuration operation, in an audit mode, on the antennas to use the RET change based on a set of existing profiles for the antennas, determining if the configuration operation in the audit mode resulted in a validation error for one of the access nodes from the antennas, and performing a configuration operation, in a real time mode, on the antennas to use the RET change if it is determined that configuration operation in the audit mode did not result in a validation error.

### TECHNICAL BACKGROUND

A wireless network, such as a cellular network, can include a plurality of access nodes (e.g., base stations), with each access node serving multiple wireless devices or user equipment (UE) in a geographical area covered by a radio frequency (RF) transmission provided by the access node. As technology has evolved, different carriers within the cellular network may utilize different types of radio access technologies (RATs). RATs can include, 5G NR next generation NodeBs (gNodeBs) or alternatively may be exclusively 5G cellular systems. Wireless devices closer to a 5G antenna are more likely to receive the benefits of the 5G technology.

As wireless networks evolve and grow, there are ongoing challenges to adjust antennas to provide high quality service and higher performance to increasing numbers of wireless devices in various coverage areas of the wireless network.

### OVERVIEW

Exemplary embodiments described herein include methods, systems, and processing nodes for identifying neighbor access nodes in a wireless network. An exemplary method for validating remote electrical tilt (RET) changes to a wireless network includes receiving information associated with a RET change for use by at least one access node from a antennas in a geographic area, the RET change having at least one RET change parameter not previously available in the wireless network, performing a configuration operation on the antennas to use the RET change based on a set of existing profiles for the antennas, the configuration operation run in an audit mode, determining if the configuration operation in the audit mode resulted in a validation error for one of the access nodes from the antennas, and performing a configuration operation, in a real time mode, on the antennas to use the RET change if it is determined that configuration operation in the audit mode did not result in a validation error.

A wireless access cell coverage can be determined by the site location (height) and antenna tilts. Antenna tilts are determined by physical tilt and electrical tilt. The method and systems are used to change the electrical tilt on the cell to optimize the cell coverage.

In rural area the cells can be at maximum coverage by setting total tilt=0, but in urban areas and densely populated areas, electrical tilt is optimized to control the interference between cells and provide the best user experience by reducing dropped calls and improving user throughput.

The methods and systems read user input file, audit, and change the electrical tilts read from OSS. The methods and system can audit whether all cells under the same sectors are using the same tilts, to make sure all cells (different frequencies or layers) under the same sectors are coverage the same area.

### BRIEF DESCRIPTION OF THE DRAWINGS

FIG. 1 illustrates an exemplary system for validating remote electrical tilt (RET) changes in a wireless network.

FIG. 2 illustrates an exemplary processing node used in a system for validating RET changes in a wireless network.

FIG. 3 illustrates an exemplary access node used in a system for validating RET changes in a wireless network.

FIG. 4 illustrates an exemplary method for validating RET changes in a wireless network.

FIG. 5 is a table illustrating an exemplary parameters used for validating RET changes in a wireless network.

FIG. 6 is a table illustrating an exemplary parameters used for validating RET changes in a wireless network.

FIG. 7 is validation entry table used as part of performing a configuration operation as part of validating RET changes in a wireless network.

FIG. 8 is a table illustrating an exemplary validation report generated as part of validating RET changes in a wireless network.

### DETAILED DESCRIPTION

A drive test may be performed by driving geographic areas and testing coverage for a wireless network of mobile network operator (MNO). The coverage may also be predicted during site design phase. The coverage may be full or low in certain geographic areas. Data from the drive test or coverage prediction is utilized to determine if changes should be made to improve coverage and/or minimize interference based on overlap with other cells. The decision to optimize antenna upward and/or downward tilt is made based on the drive test or coverage prediction. Antenna tilt can be optimized by controlling down tilt to control cell coverage and interference with other cells.

Remote electrical tilt (RET) is a feature found in cell, site, sector, and/or layer level antennas that allow the tilt angle of the antenna to be controlled remotely. Electrical tilt, also known as electronic tilt, is an adjustable parameter that controls the radiation pattern of an antenna. It is achieved by modifying the phase and amplitude of the signals sent to different antenna elements within an array. Electrical tilt allows for beamforming, which shapes and directs the radio frequency (RF) energy in specific directions. By adjusting the electrical tilt, the coverage area of the antenna can be modified without physically moving the antenna itself. Electrical tilt may be adjusted remotely by network operators through a base station or antenna control system such as remote electrical tilt (RET).

Antenna tilt is used to optimize signal coverage in cellular networks. By adjusting the tilt, network operators can shape the radiation pattern of the antenna to focus the signal where it is needed the most, such as densely populated areas or specific coverage gaps. Antenna tilt is also used to mitigate interference between neighboring cells. By adjusting the tilt, operators can minimize the overlap of signals and reduce interference, improving network performance and overall quality of service.

In a cellular network, multiple sectors are often created to divide the coverage area. Each sector may have its own antenna(s) with adjustable tilt. By adjusting the tilt of each sector's antenna(s), operators can control the coverage area of each sector and ensure efficient frequency reuse. Antenna tilt can be used to manage network capacity. By adjusting the tilt, operators can shape the coverage area and direct the signal toward areas with high user demand, maximizing the capacity and throughput of the network.

Antenna tilt adjustments should be carefully planned and optimized to achieve the desired coverage objectives. Mobile network operators rely on network planning tools, field measurements, and analysis to determine the appropriate tilt angles for optimal network performance.

In examples described herein, an input file, such as an excel spreadsheet, may be generated with remote electrical tilt (RET) changes to optimize wireless network coverage. RET changes may be made on a cell, site, sector, and/or layer level. The RET changes, or final tilt, are input as an input file.

RET changes in the input file to be made to a wireless network by a mobile network operator are validated before the RET changes are made to the wireless network. The disclosed embodiments illustrate methods, systems, and computer readable mediums for validating network by performing a configuration operation using an audit mode, on RET changes to be made to antennas prior to performing the configuration operation in a normal or real time mode as part of the operation support system (OSS) for the wireless network.

The configuration operation, in audit mode, is performed for the antennas based on a set of existing profiles for the set of antennas. The set of profiles contain operating inputs used by the antennas during operation. The configuration operation performed in audit mode on antennas is used to validate RET changes to the antennas by determining if an error or discrepancy exists with the changes to the antennas. If no errors or discrepancy exists, then a configuration operation, such as RET changes, can be performed on the antennas in a normal or real time mode in order to implement the RET changes. If an error or discrepancy is identified, then the error or discrepancy can be addressed or corrected prior to performing the configuration operation in the real time mode. As such, the configuration operation in audit mode uses RET change data but does not make any RET changes to the antennas. The configuration operation in real time mode may make RET changes to the configuration information, for the antennas in order to implement the RET change.

The validation of RET changes in a wireless network using an audit mode as part system configuration for antennas in a wireless network can have an impact on the operational performance of the wireless network. Currently, a technician making a change to the antennas of the wireless network to implement RET changes by performing a configuration operation on a antennas in a normal or real time mode can result in initial performance degradation if there is an error in the configuration change. The performance degradation may include an increase in dropped calls, reduced data rates for customers, or lower values of other key process indicators. By creating an audit mode for the RET changes, the current configuration for the antennas with the network and produce validation results to determine any antenna configuration changes that are needed prior to implementing the RET changes into the wireless network as part of the normal or real time configuration operation. The validation of RET changes may be performed for frequency diversity duplexing (FDD) for 4G LTE and/or 5G or time diversity duplexing (TDD) for 5G.

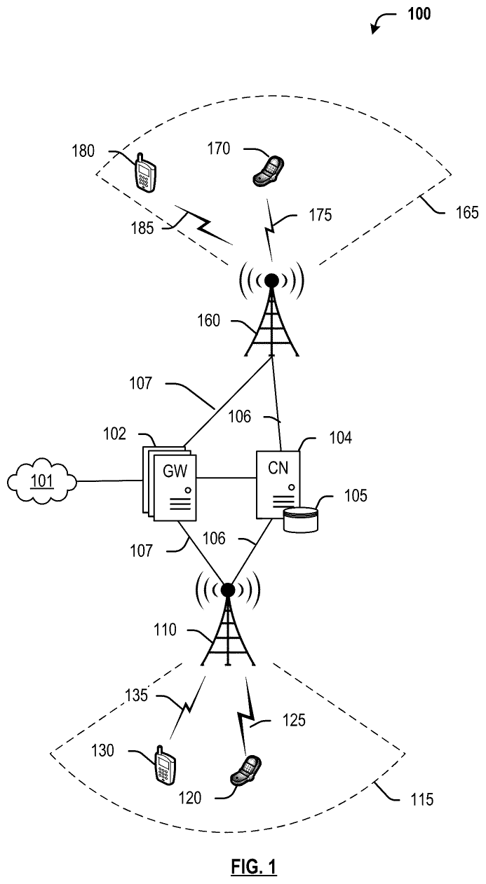

Similar operations may be performed by an exemplary system described herein and comprising at least a processing node and a processor coupled to the processing node. The processing node can be communicatively coupled to any other network node within the wireless network, such as an access node or a controller node. These and other embodiments are further described herein and with reference to FIGS. 1-8.

FIG. 1 depicts an exemplary system 100 for identifying neighbor access nodes in a wireless network. System 100 comprises a communication network 101, gateway node 102, controller node 104, access nodes 110 and 160, and wireless devices 120, 130, 170, and 180. Collectively, gateway node 102, controller node 104, access node 110, and access node 160 may be referred to as network nodes. Access node 110 and access node 160 may include an access node of any type, including macrocell access nodes such as Long-Term-Evolution (LTE) eNodeBs or 5G New Radio (NR) gNodeBs, mini access nodes, home eNodeBs or gNodeBs, etc.

Each one of access nodes 110 and 160 may include a plurality of antenna arranged in one or more arrays, wherein each antenna array is configured to steer or form one or more beams to wireless devices attached thereto, including wireless devices 120, 130. Access node 110 communicates with wireless devices 120, 130 over corresponding wireless communication links 125, 135 located within a communication sector 115. Similarly, access node 160 communicates with wireless devices 170 and 180 over corresponding communication links 175 and 185 within a communication sector 165. The area of coverage for communication sectors 115 and 165 can be determined by characteristics for the antenna used in access nodes 110 and 150. The communication links 125, 135, 175, and 185 can include direct communication links, formed beams, multiple-input-multiple-output (MIMO), and so on.

The communication links 125, 135, 175, and 185 are created based on a communication protocol. The communication protocol that is used is based on the technology capabilities of the wireless devices 120, 130, 170, and 180 as well as access nodes 110 and 160. For example, wireless devices 120 and 130 as well as access node 110 may be capable of communicating over communication links 125 and 135 using 5G RATs. Wireless devices 120 and 130 contact access node 110 in order to establish communication links 125 and 135. Access node 110 establishes the communication link based on a set of network technical operating parameters. The set of network technical operating parameters, referred to as RET changes, may include the degree of upward or downward electrical tilt for antennas.

In some embodiments, one or more of the communication links 125, 135, 175, and 185 may be created as part of a self-organizing network (SON). A SON is a framework for network automation across 3 primary areas: network configuration management, optimization, and self-healing. A SON is a collection of modules which helps eliminate manual configuration of network elements from deployment right through to dynamic optimization. A SON makes changes to the network by sending plans to the operation system support (OSS). SON functions across all technologies and vendors.

System 100 is shown having two access nodes 110 and 160 in geographic proximity to each other. As such, access nodes 110 and 160 may be referred to as a antennas in a geographic area. Further, access node 110 and access node 160 are shown operating one communication sector 115 and 165, respectively. Each of the access nodes 110, 160 establish communication links with wireless devices, in their communication sectors 115 and 165, respectively, based on profiles that are created for the antennas in order to implement one or more RET changes used in system 100. In some embodiments, access node 110 and/or access node 160 may include antenna configured to communicate over corresponding wireless communication links in more than one communication sector. In some embodiments, more than two access nodes may be present within the geographic area. In other embodiments, different communication protocols may be used.

As described herein, a network node (e.g., gateway node 102 or controller node 104) communicatively coupled to other network nodes (e.g., access nodes 110, 160) within system 100 can be configured to validate features in a wireless network prior to implementing and using the feature in the network nodes. The validation includes receiving information associated with a RET change for use by at least one access node in a geographic area. The RET change has at least one RET change parameter not previously available in the system. The validation also includes performing a configuration operation, in an audit mode, on a antennas in a geographic area to use the RET change based on a set of existing profiles for the antennas. The validation additionally includes determining if the configuration operation in the audit mode resulted in any validation errors for the antennas. If the configuration operation in audit mode did not result in any validation errors, then the configuration operation can be performed in a real time mode on the antennas in order to implement and use the RET change.

Access node 110 and access node 160 can be any network node configured to provide communication between wireless devices (e.g., wireless devices 120, 130 and 170, 180 respectively) and communication network 101, including standard access nodes and/or short range, low power, small access nodes. For instance, access node 110 and/or access node 160 may include any standard access node, such as a macrocell access node, base transceiver station, a radio base station, next generation or gigabit NodeBs (gNBs) in 5G networks, or the like. In an exemplary embodiment, a macrocell access node can have a coverage area in the range of approximately five kilometers to thirty five kilometers and an output power in the tens of watts. In other embodiments, one or both of access node 110 and access node 160 can be a small access node including a microcell access node, a picocell access node, or the like such as a home NodeB or a home eNodeB device.

Access nodes 110 and 160 can comprise processors and associated circuitry to execute or direct the execution of computer-readable instructions to perform operations such as those further described herein. Briefly, access nodes 110 and 160 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Further, access nodes 110 and 160 can receive instructions and other input. Access node 110 and access node 160 communicate with gateway node 102 and controller node 104 via communication links 106, 107. Access node 110 and/or access node 160 may communicate with other access nodes (not shown) using a direct link such as an X2 link or similar.

Wireless devices 120, 130, 170, and 180 may be any device, system, combination of devices, or other such communication platform capable of communicating wirelessly with access node 110 and access node 160, respectively, using one or more frequency bands deployed therefrom. Wireless devices 120, 130, 170, and 180 may be, for example, a mobile phone, a wireless phone, a wireless modem, a personal digital assistant (PDA), a voice over internet protocol (VOIP) phone, a voice over packet (VOP) phone, or a soft phone, as well as other types of devices or systems that can exchange audio or data via access node 110. Other types of communication platforms are possible.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 120, 130, 170, and 180. Wireless network protocols can comprise Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106, 107 can use various communication media, such as air, space, metal, optical fiber, or some other signal propagation path-including combinations thereof. Communication links 106, 107 can be wired or wireless and use various communication protocols such as Internet, Internet protocol (IP), local-area network (LAN), optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, or combinations thereof. Communication links 106, 107 may include S1 communication links. Other wireless protocols can also be used. Communication links 106, 107 can be a direct link or might include various equipment, intermediate components, systems, and networks. Communication links 106, 107 may comprise many different signals sharing the same link.

Gateway node 102 can be any network node configured to interface with other network nodes using various protocols. Gateway node 102 can communicate data over system 100. Gateway node 102 can be a standalone computing device, computing system, or network component, and can be accessible, for example, by a wired or wireless connection, or through an indirect connection such as through a computer network or communication network. For example, gateway node 102 can include a serving gateway (SGW) and/or a public data network gateway (PGW), etc. One of ordinary skill in the art would recognize that gateway node 102 is not limited to any specific technology architecture, such as Long Term Evolution (LTE) or 5G NR and can be used with any network architecture and/or protocol.

Gateway node 102 can comprise a processor and associated circuitry to execute or direct the execution of computer-readable instructions to obtain information. Gateway node 102 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Gateway node 102 can receive instructions and other input.

Controller node 104 can be any network node configured to communicate information and/or control information over system 100. Controller node 104 can be configured to transmit control information associated with a handover procedure. Controller node 104 can be a standalone computing device, computing system, or network component, and can be accessible, for example, by a wired or wireless connection, or through an indirect connection such as through a computer network or communication network. For example, controller node 104 can include a mobility management entity (MME), a Home Subscriber Server (HSS), a Policy Control and Charging Rules Function (PCRF), an authentication, authorization, and accounting (AAA) node, a rights management server (RMS), a subscriber provisioning server (SPS), a policy server, etc. One of ordinary skill in the art would recognize that controller node 104 is not limited to any specific technology architecture, such as Long Term Evolution (LTE) or 5G NR and can be used with any network architecture and/or protocol.

Controller node 104 can comprise a processor and associated circuitry to execute or direct the execution of computer-readable instructions to obtain information. Controller node 104 can retrieve and execute software from storage, which can include a disk drive, a flash drive, memory circuitry, or some other memory device, and which can be local or remotely accessible. In an exemplary embodiment, controller node 104 includes a database 105 for storing information, such as signaling capabilities and historical signal conditions for wireless devices attached to access node 110 and/or access node 160, default operational parameters, such as frequencies or carrier spacings, for communication sectors deployed by access node 110 and/or access node 160, and so on. This information may be requested by or shared with access node 110 and/or access node 160 via communication links 106, 107, X2 connections, and so on. The software comprises computer programs, firmware, or some other form of machine-readable instructions, and may include an operating system, utilities, drivers, network interfaces, applications, or some other type of software, and combinations thereof. Controller node 104 can receive instructions and other input.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g., between access nodes 110 and 160 and communication network 101.

The methods, systems, devices, networks, access nodes, and equipment described herein may be implemented with, contain, or be executed by one or more computer systems and/or processing nodes. The methods described above may also be stored on a non-transitory computer readable medium. Many of the elements of communication system 100 may be, comprise, or include computers systems and/or processing nodes, including access nodes, controller nodes, and gateway nodes described herein.

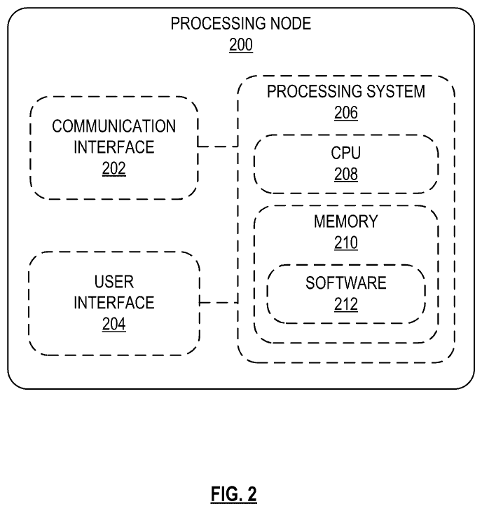

FIG. 2 depicts an exemplary processing node 200 for validating RET changes in a wireless network. Processing node 200 comprises a communication interface 202, entry interface 204, and processing system 206 in communication with communication interface 202 and entry interface 204. Processing system 206 includes a central processing unit (CPU) 208, and a memory 210, which can comprise a disk drive, flash drive, memory circuitry, or other memory device. Memory 210 can store computer programs, firmware, or some other form of machine-readable instructions, including an operating system, utilities, drivers, network interfaces, applications, or some other type of software. Further, memory 210 can store software 212, which may be executed to perform the operations described herein. Processing system 206 may include other circuitry to retrieve and execute software 212 from memory 210. Processing node 200 may further include other components such as a power management unit, a control interface unit, etc., which are omitted for clarity. Communication interface 202 permits processing node 200 to communicate with other network elements. Entry interface 204 permits the configuration and control of the operation of processing node 200.

In an exemplary embodiment, software 212 includes instructions that enable CPU 208 to perform operations for validating features in a wireless network that include receiving information associated with a RET change for use by one or more antennas in a geographic area, the RET change having one or more RET change parameters not previously available in the wireless network. For example, the RET change parameter may be a new RET change parameter, such as uptilt or down tilt. In addition, or as an alternative, the RET change parameter may be a new value (down tilt or uptilt) for an existing antenna configuration for a cell, sector, layer and/or carrier.

The software 212 also include instructions that enable CPU 208 to further perform a configuration operation, in an audit mode, on the set of access node in the geographic area to use the RET change based on a set of existing profiles for the antennas and determine if the configuration operation in the audit mode resulted in a validation error for one of the antennas. Further, the instructions enable CPU 208 to perform a configuration operation in a real time mode on the antennas to use the RET change if it is determined that the configuration operation in the audit mode did not result in a validation error. In some embodiments, the instructions for performing the configuration operation in real time mode may include instructions for re-tuning the antennas while performing the configuration operation in audit mode does not include re-tuning the antennas.

In some embodiments, software 212 includes instructions that enable CPU 208 to generate a validation report and provide the validation report if it is determined that the configuration operation in audit mode resulted in validation errors. The instructions may further enable CPU 208 to perform a configuration operation in real time mode when the validation errors are corrected.

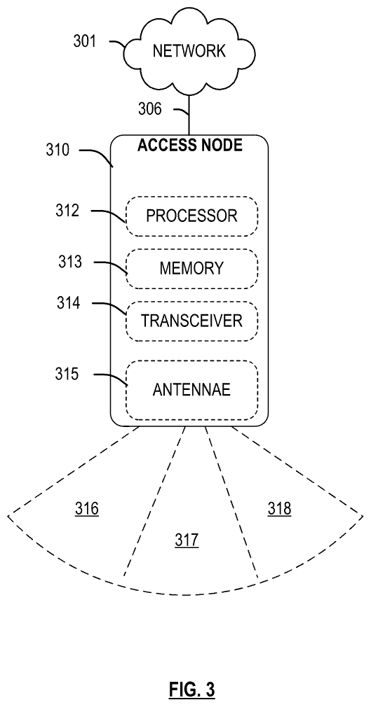

FIG. 3 depicts an exemplary access node 310 for use in conjunction with identifying neighbor access nodes in a wireless network. Access node 310 may be configured as an access point for providing network services from network 301 to end-user wireless devices via a radio-air interface deployed therefrom. Access node 310 is illustrated as comprising a processor 312, a memory 313 (for storing instructions that are performed by processor 312), a transceiver 314, and antenna 315 for deploying a radio air interface over communication sectors 316, 317, and 318. Antenna 315 may be an antenna array. One transceiver and set of antenna are illustrated herein solely to simplify the written description, and it may be evident to those having ordinary skill in the art, that any combination of transceivers and antenna may be incorporated in order to deploy different communication sectors that are configured to facilitate wireless communication with other network nodes on network 301. For example, antenna 315 may include a first directional antenna for communicating wireless signals in communication sector 316, a second directional antenna for communicating wireless signals in communication sector 317, and a third directional antenna for communicating wireless signals in communication sector 318. Further, access node 310 is communicatively coupled to network 301 via communication interface 306, which may be any wired or wireless link as described above.

In an exemplary embodiment, access node 310 may be communicatively coupled via interface 306 to a processor node (e.g., processor node 200) over network 301, with the processor node configured to perform operations for validating RET changes in a wireless network containing access node 310. In some embodiments, access node 310 may provide information to the processing node regarding its current operating configuration. The processing node may request the information while performing a configuration operation in audit mode. The information can include the current profile being used by an antenna or may include specific configuration parameters being used by the antenna. In addition, or as an alternative, the processing node may send instructions to access node 310 over network 301 while performing a configuration operation in real time mode.

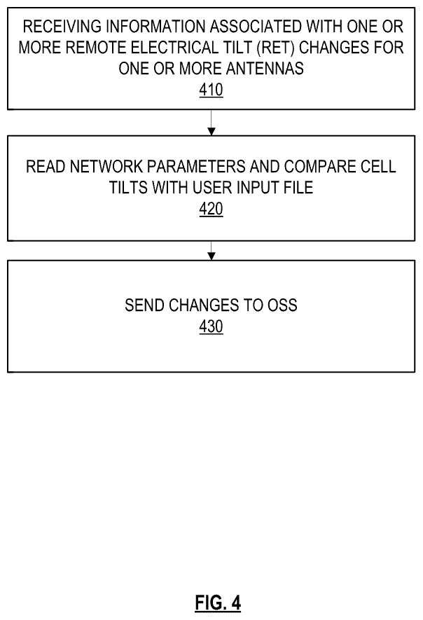

FIG. 4 illustrates an exemplary method for identifying neighbor access nodes in a wireless network. The method will be discussed with reference to the exemplary communication system 100 illustrated in FIG. 1. However, the method can be implemented with any suitable communication system. In addition, although FIG. 4 depicts steps performed in a particular order for purposes of illustration and discussion, the methods discussed herein are not limited to any particular order or arrangement. One skilled in the art, using the disclosures provided herein, will appreciate that various steps of the methods can be omitted, rearranged, combined, and/or adapted in various ways.

At 410, information associated with a RET change for use by one or more antennas in a geographic area is received. The RET change includes at least one RET change not previously implemented in the wireless network. The RET change parameter from a user input file are the final RET tilts on the cell. The antennas may be associated capable of operation using 4G LTE or 5G RAT. These access nodes may include macrocell access nodes such as 5G New Radio (NR) gNodeBs, mini access with one or more access nodes nodes, home gNodeBs, and the like. In some embodiments, one or more of the access nodes may also be capable of operation in using other RATs.

At 420, the network parameter values from OSS are read and compared with input values from the input file. At 430, if the input tilt values of the input file are different from the network values from the OSS, the changes are sent to the OSS.

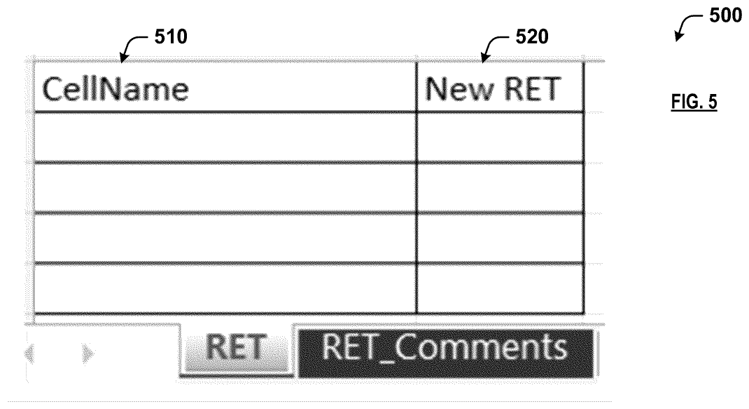

FIG. 5 is a table illustrating an exemplary RET change list 500. RET change list 500 may be as an input file for validating RET changes in a wireless as described above. More specifically, the change list 500 may include information associated with a new RET change for one or more cells in a wireless network.

RET change list 500 each of columns 510 and 520 include a RET change parameter that is used to make RET changes. Column 510 indicates the cell name list. Column 520 indicates the new electric tilt on the cell. Each of columns 510 and 520 identifies one or more inputs that can be used by the OSS to implement the RET changes, identified by the rows.

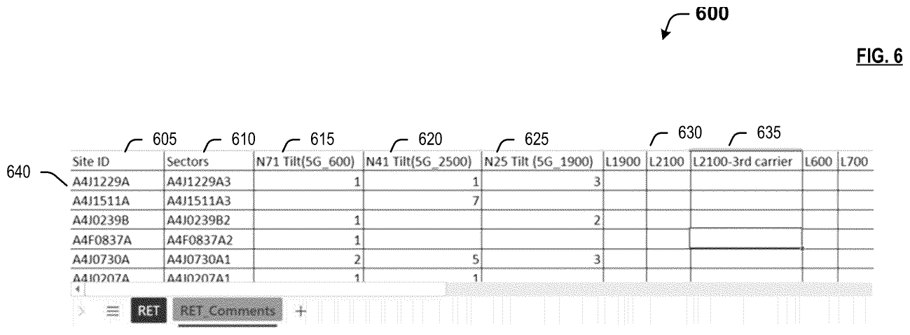

FIG. 6 is a table illustrating an exemplary RET change list 600. RET change list 600 may be used as an input file for validating RET changes in a wireless as described above. This is another format of user input. The list 500 and list 600 are combined to get the final electrical tilt changes to the cells. The RET changes may be the degree final electrical tilt of the cells. In RET change list 600 each of 605, 610, identify RET changes by site ID 605 and sector 610. RET changes may be further stratified by layers 615, 620, and 625 and/or carriers 630 and 635. Each layer on the same sector contains a cell. The RET change targets the cell level. The RET change parameters that may be made by site ID 605, sector 610, layers 615, 620, and 625, and/or carriers 630 and 635 may include the final electrical tilt value. Row 640 identifies that for Site ID A4J1229A, Sector A4J1229A3, final electrical tilt being made to each of layers 615 and 620 and final electrical tilt being made to layer 625. A blank indicates that changes are not being made to the tilt of carriers 630 and 635.

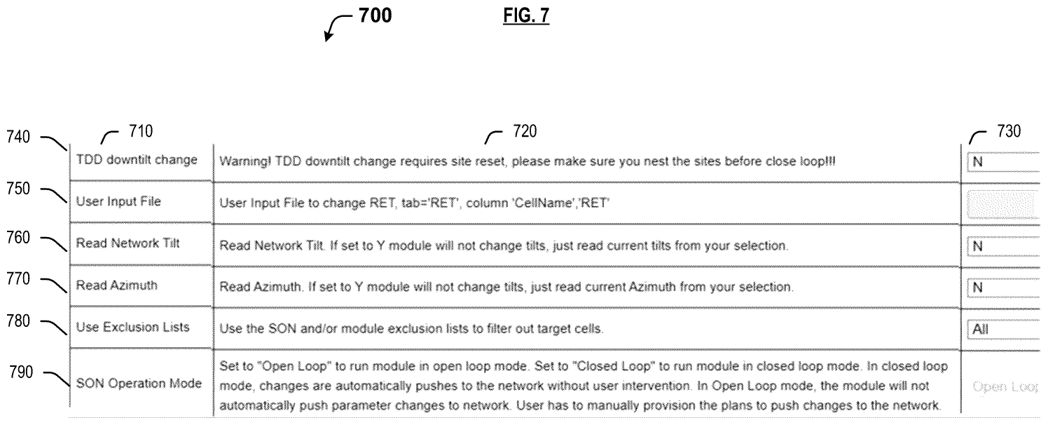

FIG. 7 is an exemplary screenshot 700 from a user interface used as part of performing a configuration operation. Screenshot 700 may be displayed on a display screen or display device included as part of entry interface in processing node 200. Each of rows 740 to 760 include input entry in column 730, and a description associated with the request, in columns 710 and 720.

More specifically, row 740 includes input as a confirmation for safety when TDD down tilt changes are to be made in real time because TDD cell tilt changes are service impacting. An engineer enters any numbers as input to accept the risk of making changes to the network and will verify the sites are on air after parameters are changed.

Row 750 user input file. For example, input files such those shown in FIGS. 5 and 6, above.

Row 760 and row 770 include data as part of the profiles, that may be accessed for further information. Row 760 provides access to azimuth information based on market, site, and sector. Row 770 provides current RET data based on market, site, and sector. The data that is accessed from rows 760 and 770 may be used for troubleshooting any issues that may occur during validation of the RET changes.

Row 780 includes whether to use exclusion lists as part of the configuration operation. The exclusion lists may be created and used as part of the configuration of a SON or other lists used to filter out target access nodes or cells. Dropdown entry box 775 may also include the names of one or more exclusion lists that can be used.

Row 790 includes the mode of operation with respect to configuration of a SON as part of the configuration operation. ‘Open Loop’ means no changes to OSS and only give results what will be change to OSS in an excel file. ‘Close Loop’ means changes are sent to OSS.

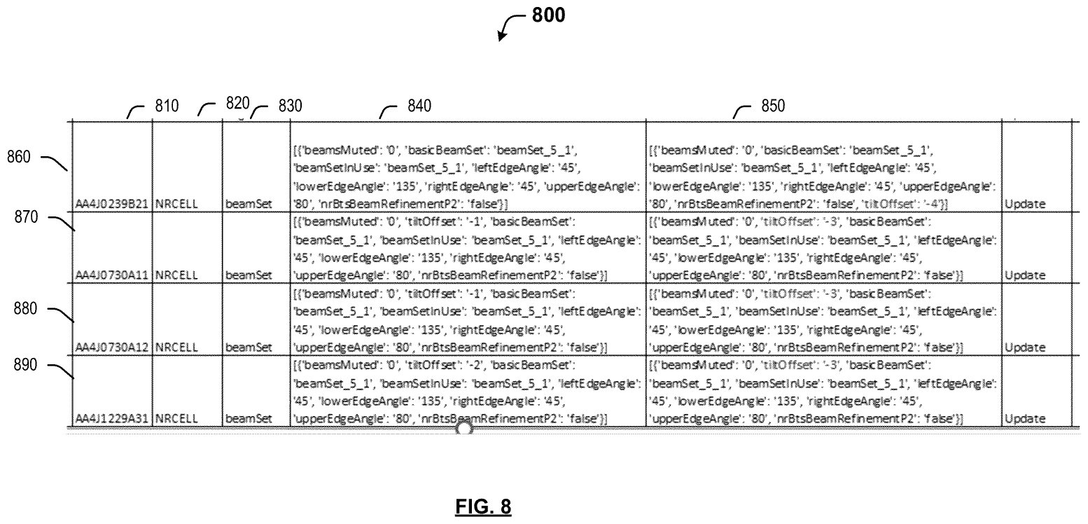

FIG. 8 is a table illustrating an exemplary validation report 800. Validation report 800 may be generated as part of validating RET changes in a wireless network. More specifically, validation report 800 may be generated as part of performing a configuration operation in an audit mode on antennas to implement RET changes. Validation report 800 contains a list of error settings on the location 810, such as cell, sector, site, layer and/or carrier.

The location 810 represents a cell that contains the antenna(s) that were tested as part of the configuration operation. Column 820 identifies parameter sets containing the parameters. In this example it is for an NR cell under parameter set NRCELL. Column 830 identifies the parameter name of RET changes. In this example, beamforming changes are being made. Column 840 is the current OSS value for the location and column 850 indicates the audit values and that a discrepancy has been found in its configuration for implementing the RET changes. The parameters in columns 820 and 822 for the site and cell may include information identifying the sitename for the access node as well as any specific antenna or sector information for that access node.

Each of rows in validation report 800 identifies a different error or discrepancy generated as a result of the configuration operation performed in an audit mode. Each of the rows 860-890 include errors or discrepancies. The errors or discrepancies may be incompatibility of direction, duration and/or antenna settings based on the proposed RET changes.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the disclosure. The following claims specify the scope of the disclosure. Note that some aspects of the best mode may not fall within the scope of the disclosure as specified by the claims. Those skilled in the art will appreciate that the features described above can be combined in various ways to form multiple variations of the disclosure. As a result, the disclosure is not limited to the specific embodiments described above, but only by the following claims and their equivalents.

What is claimed is:

1. A method for validating remote electrical tilt changes in a wireless network, the method comprising:
receiving information associated with one or more remote electrical tilt (RET) changes for one or more antennas for one or more access nodes in a wireless network;
performing a configuration operation on a set of existing profiles for the one or more antennas, wherein the configuration operation is run in an audit mode for the one or more RET changes for the one or more antennas;
determining if the configuration operation in the audit mode resulted in one or more validation errors for the one or more RET changes for the one or more antennas; and
in response to determining the configuration operation does not result in one or more validation errors, performing a configuration operation in a real time mode for the one or more RET changes for the one or more antennas.

2. The method of claim 1, wherein the one or more antennas are an antenna array system.

3. The method of claim 2, wherein the one or more antennas are for one of a cell or a sector.

4. The method of claim 3, wherein the one or more antennas are for one or more layers of the sector.

5. The method of claim 4, wherein the one or more antennas are for one or more carriers of the sector.

6. The method of claim 1, wherein the one or more RET changes for the one or more antennas for the one or more access nodes is performed by an operation system support (OSS).

7. The method of claim 1, further comprising:
correcting one or more validation errors if it is determined that one or more validation errors are reported; and
performing a configuration operation in the real time mode to execute the one or more RET changes for the one or more antennas.

8. The method of claim 1, wherein the one or more RET changes comprises down tilt or uptilt for the one or more antennas.

9. The method of claim 1, wherein determining if the configuration operation in the audit mode resulted in a validation error further includes:
generating a validation report; and
providing the validation report.

10. A system, the system comprising:
antennas for one or more access nodes in a wireless network located in a geographic region; and
a processing node communicatively coupled to the antennas, the processing node configured to perform operations comprising:
receiving information associated with one or more remote electrical tilt (RET) changes for the antennas;
performing a configuration operation on a set of existing profiles for the one the antennas, wherein the configuration operation is run in an audit mode for the one or more RET changes for the antennas;
determining if the configuration operation in the audit mode resulted in one or more validation errors for the one or more RET changes for the antennas; and
in response to determining the configuration operation does not result in one or more validation errors, performing a configuration operation in a real time mode for the one or more RET changes for the antennas.

11. The system of claim 10, wherein the one or more RET changes for the antennas for the antennas is performed by an operation system support (OSS).

12. The system of claim 10, further comprising:
correcting the one or more validation errors if it is determined that one or more validation errors are reported; and
performing a configuration operation in the real time mode to execute the one or more RET changes for the antennas.

13. The system of claim 10, wherein the one or more RET changes comprises down tilt or uptilt for the antennas.

14. The system of claim 10, wherein determining if the configuration operation in the audit mode resulted in a validation error further includes:
generating a validation report; and
providing the validation report.

15. A non-transitory computer readable medium, storing instructions executed by a processor to perform operations comprising:
receiving information associated with one or more remote electrical tilt (RET) changes for one or more antennas for one or more access nodes in a wireless network;
performing a configuration operation on a set of existing profiles for the one or more antennas, wherein the configuration operation is run in an audit mode for the one or more RET changes for the one or more antennas;
determining if the configuration operation in the audit mode resulted in one or more validation errors for the one or more RET changes for the one or more antennas; and
in response to determining the configuration operation does not result in one or more validation errors, performing a configuration operation in a real time mode for the one or more RET changes for the one or more antennas.

16. The non-transitory computer readable medium of claim 15, wherein the one or more antennas are an antenna array system.

17. The non-transitory computer readable medium of claim 16, wherein the one or more antennas are for one of a cell or a sector.

18. The non-transitory computer readable medium of claim 17, wherein the one or more antennas are for one or more layers of the sector.

19. The non-transitory computer readable medium of claim 18, wherein the one or more antennas are for one or more carriers of the sector.

20. The non-transitory computer readable medium of claim 19, further comprising:
correcting the one or more validation errors if it is determined that one or more validation errors are reported; and
performing a configuration operation in the real time mode to execute the one or more RET changes for the one or more antennas.
